(19) United States
(12) Patent Application Publication
(10) Pub. No.: US 2022/0081556 A1
(43) Pub. Date: Mar. 17, 2022

(54) COMPOSITION INCLUDING POLYESTER RESIN, ACRYLATE, AND VINYL ESTER AND METHOD OF USING THE SAME

(71) Applicant: 3M INNOVATIVE PROPERTIES COMPANY, St. Paul, MN (US)

(72) Inventors: Yu Yang, Eden Prairie, MN (US); Mark F. Schulz, Lake Elmo, MN (US); Andrew D. Norlander, Woodbury, MN (US); Ruijian Xu, Woodbury, MN (US); Richard J. Pokorny, Maplewood, MN (US)

(21) Appl. No.: 17/415,934

(22) PCT Filed: Dec. 18, 2019
(86) PCT No.: PCT/IB2019/061028

§ 371 Date: Jun. 18, 2021

Related U.S. Application Data
(60) Provisional application No. 62/783,039, filed on Dec. 20, 2018.

(51) Int. Cl. C08L 67/06; C08L 31/04; C08F 222/10; C08F 220/28; C08F 283/01; C08F 290/06; C08K 5/14; C08K 5/18; C08K 5/098; C08K 3/34; C09D 5/34

(52) U.S. Cl. CPC C08L 67/06; C08L 31/04; C08F 222/103; C08F 220/286; C08F 283/01; C09D 5/34; C08K 5/14; C08K 5/18; C08K 5/098; C08K 3/346; C08F 290/061

(57) ABSTRACT

The composition includes a polyester resin comprising at least one α,β-unsaturated ester group, an acrylate or methacrylate, a vinyl ester represented by formula R—[C(O)—O—CH—CH₂]n, wherein R is alkyl, aryl, or a combination thereof and n is 1 or 2, and a metal salt of a carboxylic acid. A method of repairing a damaged surface using the composition is also described.

### CROSS-REFERENCE TO RELATED APPLICATION

This application claims priority to U.S. Provisional Application No. 62/783,039, filed Dec. 20, 2018, the disclosure of which is incorporated by reference in its entirety herein.

### BACKGROUND

Automobile body repair is often carried out with a body repair compound, also called body filler. A body repair compound can include a thermosetting resin, fillers, promoters, and other additives that are mixed with a catalyst to facilitate cross-linking at room temperature. After mixing, a technician spreads the body filler onto a damaged surface, allows the body filler to harden, and then sands the hardened body filler to conform to the desired surface contour. The process can be repeated two or more times until the damaged area of the vehicle is sufficiently filled, and the contour of the original surface is matched.

Automotive body fillers often include unsaturated polyester resins. Unsaturated polyester resins typically contain α,β-unsaturated polyesters and 30 to 50 percent by weight copolymerizable monomers. Styrene, due to its well-understood reactivity profiles with unsaturated polyester resins and other monomers and its relatively low cost, is by far the dominant copolymerizable monomer used in unsaturated polyester resins. Styrene has a relatively high volatility which results in its being released from both uncured resins at room temperature and at much higher rates during cure. The Environmental Protection Agency (EPA) included styrene in its Toxic Release Inventory (TRI) in 1987 and classifies it as a possible carcinogen. Organizations such as the Occupational Safety and Health Administration (OSHA) and the Clean Air Act Amendments (CAAA) have included styrene in a list of volatile organic compounds to which exposure should be limited.

Some styrene-free body filler compositions have been described. See, for example, JP2005255937, published Sep. 22, 2005, and U.S. Pat. No. 5,068,125 (Meixner et al.). Certain acrylate and methacrylate monomers have been suggested as equivalents for styrene in body filler applications. See, for example, U.S. Pat. No. 4,745,141 (Akiyama et al.) and UK Pat. Appl. GB 2284424, published Jun. 7, 1995.

### SUMMARY

While acrylates and methacrylate monomers have been suggested as an equivalent of styrene in body filler applications, atmospheric oxygen tends to retard polymerization of these monomers in combination with unsaturated resins, resulting in an under-cured or tacky surface. The present disclosure provides a composition that includes a resin having at least one α,β-unsaturated ester group, an acrylate or methacrylate, a vinyl ester, and a metal carboxylate. The composition can be cured using free radical polymerization at ambient conditions and can be formulated as a body filler. The composition can provide curing, adhesion, and sanding properties useful for body fillers and does not require styrene.

In one aspect, the present disclosure provides a composition including a polyester resin comprising at least one α,β-unsaturated ester group, an acrylate or methacrylate, a vinyl ester represented by formula R—[C(O)—O—CH═CH₂]., wherein R is alkyl, aryl, or a combination thereof and n is 1 or 2, and a metal salt of a carboxylic acid.

The composition can further contain at least one of a tertiary amine and inorganic filler. The composition can be packaged, for example, as a two-part body repair composition, wherein a first part comprises the composition and a second part comprises at least one of an organic peroxide or organic hydroperoxide.

In another aspect, the present disclosure provides a cured composition prepared from such a composition.

In another aspect, the present disclosure provides a method of repairing a damaged surface. The method includes combining the composition described above with at least one of an organic peroxide or organic hydroperoxide, applying the composition comprising the organic peroxide or hydroperoxide to the damaged surface; and curing the composition on the damaged surface.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility, but may be swellable in the presence of an appropriate solvent.

The term “polymer or polymeric” will be understood to include polymers, copolymers (e.g., polymers formed using two or more different monomers), oligomers or monomers that can form polymers, and combinations thereof, as well as polymers, oligomers, monomers, or copolymers that can be blended.

“Alkyl group”, “alkenyl group” and the prefix “alk-” are inclusive of both straight chain and branched chain groups. In some embodiments, alkyl groups have up to 30 carbons (in some embodiments, up to 20, 15, 12, 10, 8, 7, 6, or 5 carbons) unless otherwise specified.

“Alkylene” is the multivalent (e.g., divalent or trivalent) form of the “alkyl” groups defined above. “Alkenylene” is the multivalent (e.g., divalent or trivalent) form of the “alkenyl” groups defined above.

“Arylalkylene” refers to an “alkylene” moiety to which an aryl group is attached. “Alkylarylene” refers to an “arylene” moiety to which an alkyl group is attached.

The phrase “interrupted by at least one —O— group”, for example, with regard to an alkyl, alkenyl, alkylene, or alkenylene group refers to having part of the alkyl or alkylene on both sides of the —O— group. For example, —CH₂CH₂—O—CH₂—CH₂— is an alkylene group interrupted by an —O—. This definition applies to the other functional groups recited herein (e.g., —N(H)—, —N(H)—C(O)—, etc.).

The terms “aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term (meth)acrylate refers to an acrylate, a methacrylate, or a combination thereof. Similarly, the term (meth)acrylic refers to acrylic, a methacrylic, or a combination thereof.

The term “liquid” refers to being able to flow at ambient temperature.

Flash point is determined by the ASTM D93 Pensky-Martens method.

A “volatile organic compound” is a compound having at least one carbon atom that participates in atmospheric photochemical reactions. Unless otherwise specified, a volatile organic compound has at least one of a vapor pressure of greater than 0.1 mm Hg at 20° C. or a boiling point of less than 216° C.

All numerical ranges are inclusive of their endpoints and non-integral values between the endpoints unless otherwise stated (e.g., 1 to 5 includes 1, 1.5, 2, 2.75, 3, 3.80, 4, 5, etc.).

### DETAILED DESCRIPTION

The composition according to the present disclosure includes a polymeric resin having at least one α,β-unsaturated ester group. Unsaturated a,-unsaturated ester groups have the formula C═C—C(O)—O—. The terminal carbon of the double bond may be bonded to two hydrogen atoms, making it a terminal olefin group, or one or two other carbon atoms, making it an internal olefin. The terminal oxygen of the ester group is typically bonded to a carbon atom in the resin.

The composition according to the present disclosure can include an unsaturated polyester resin. Unsaturated polyester resins include a polyester generally formed by a polycondensation reaction of an unsaturated dicarboxylic acid or an anhydride thereof with a multifunctional hydroxy compound. Unsaturated dicarboxylic acids useful for preparing the unsaturated polyester resin typically include α,β-unsaturated acids and anhydrides thereof (e.g., maleic anhydride, maleic acid, fumaric acid, itaconic acid, citraconic acid, and citraconic anhydride). Other dicarboxylic acids or equivalents can also be included in the preparation of the unsaturated polyester resin. Examples include saturated aliphatic dicarboxylic acids having 4 to 10 carbon atoms such as succinic acid, adipic acid, sebacic acid and/or their anhydrides; cycloaliphatic dicarboxylic acids or dicarboxylic acid anhydrides having 8 to 10 carbon atoms such as tetrahydrophthalic acid, hexahydrophthalic acid, norbornene dicarboxylic acid and/or their anhydrides; and aromatic dicarboxylic acids or dicarboxylic acid anhydrides having 8 to 12 carbon atoms such as phthalic acid, phthalic anhydride, isophthalic acid, and terephthalic acid. Examples of hydroxy compounds useful for making unsaturated polyester resins include 1,2-propanediol, 1,3-propanediol, dipropylene glycol, diethylene glycol, ethylene glycol, 1,3-butanediol, 1,4-butanediol, neopentyl glycol, triethylene glycol, tripropylene glycol, and polyethylene glycols. In some embodiments, the hydroxy compounds used to make the unsaturated polyester resin excludes alkoxylated 2-butene-1,4-diol (e.g., those described in U.S. Pat. No. 5,360,863 (Meixner et al.).

The unsaturated polyester resin useful for practicing the present disclosure can comprise a dicyclopentadiene-modified unsaturated polyester resin. Dicyclopentadiene has been used to modify unsaturated polyester resins in various ways. For example, cracking dicyclopentadiene (e.g., heating at a temperature of at least 140° C.) forms cyclopentadiene, which can undergo a Diels-Alder reaction with maleic acid or maleic anhydride to form nadic acid or nadic anhydride groups in the polyester backbone. In another example, maleic acid can react with one or fewer equivalents of dicyclopentadiene to form a dicyclopentenyl monoester of maleic acid. The reaction is typically carried out at a temperature lower than 140° C. to avoid cracking the dicyclopentadiene. The dicyclopentenyl monoester can then be combined with a dihydroxy compound and optionally an unsaturated dicarboxylic acid or an anhydride thereof to provide a dicyclopentenyl-end-capped polyester resin.

Mixtures of different unsaturated polyester resins may be useful in the composition according to the present disclosure. For example, a mixture of unsaturated polyesters made from different unsaturated dicarboxylic acids or anhydrides thereof and/or different dihydroxy compounds can be useful. Mixtures of dicyclopentadiene-modified unsaturated polyester resins (in some embodiments, dicyclopentenyl-end-capped polyester resin) and polyester resins not modified with dicyclopentadiene are also useful, for example, to provide a cured composition with a desirable modulus.

Unsaturated polyester resins useful for practicing the present disclosure can have a wide variety of molecular weights. In some embodiments, the unsaturated polyester resins can have weight average molecular weights in a range from 500 grams per mole to 20,000 grams per mole, 1000 grams per mole to 10,000 grams per mole, or 1000 grams per mole to 5,000 grams per mole, as measured by gel permeation chromatography using polystyrene standards. In some embodiments, the unsaturated polyester resins can have weight average molecular weights in a range from 500 grams per mole to 5,000 grams per mole, 1,000 grams per mole to 5,000 grams per mole, or 1000 grams per mole to 3,000 grams per mole, as measured by gel permeation chromatography using polystyrene standards or number average molecular weights in a range from 500 grams per mole to 5,000 grams per mole, 1,000 grams per mole to 5,000 grams per mole, or 1000 grams per mole to 3,000 grams per mole as calculated from the water collected from the condensation reaction. In some embodiments, the unsaturated polyester resin is liquid (e.g., at room temperature). Whether an unsaturated polyester resin is liquid can depend, for example, on its structure (e.g., backbone and end groups) and its molecular weight.

The synthesis of unsaturated polyesters occurs either by a bulk condensation or by azeotropic condensation in batch. The reaction can conveniently be carried out in a flask equipped with stirrer, condenser, and a jacket heater. The starting materials are typically added to the flask at room temperature and then slowly heated to a temperature in a range from 200° C. to 250° C. under conditions where water can be removed from the reaction mass to obtain desired molecular weight.

Illustrative unsaturated polyester based compositions are described in U.S. Pat. No. 5,456,947 (Parish et al.); 4,980,414 (Naton); and 5,373,036 (Parish et al.). Other illustrative unsaturated polyester based compositions are described in Int. Pat. Appl. Pub. No. WO 95/19379 (Ruggeberg). Some unsaturated polyester resins useful for practicing the present disclosure can be obtained from commercial sources, for example, Reichhold LLC, Durham, N.C.; Polynt Composites, USA, Inc., North Kansas City, Mo.; AOC, LLC, Collierville, Tenn.; DSM Resins U.S., Inc., Augusta, Ga.; Ashland Specialty Chemical Co., Columbus, Ohio; Bayer Material Science LLC, Pittsburgh, Pa.; Interplastic Corporation, St. Paul, Minn.; and Deltech Corporation, Baton Rouge, La.

The composition according to the present disclosure can include a vinyl ester resin. As would be understood by a person of ordinary skill in the art, a vinyl ester is a resin produced by the esterification of an epoxy resin with an unsaturated monocarboxylic acid. Epoxy vinyl ester resins are typically prepared, for example, by reacting a vinyl monocarboxylic acid (e.g., acrylic acid, methacrylic acid, ethacrylic acid, halogenated acrylic or methacrylic acids, cinnamic acid, and combinations thereof) and an aromatic polyepoxide (e.g., a chain-extended diepoxide or novolac epoxy resin having at least two epoxide groups) or a monomeric diepoxide. Useful epoxy vinyl ester resins typically have at least two end groups represented by formula —CH₂—CH(OH)—CH₂—O—C(O)—C(R″)═CH(R′), wherein R″ is hydrogen, methyl, or ethyl, wherein the methyl or ethyl group may optionally be halogenated, wherein R′ is hydrogen or phenyl, and wherein the terminal CH₂ group is linked directly or indirectly to the aromatic group described below (e.g., through a phenolic ether functional group). The aromatic polyepoxide or aromatic monomeric diepoxide typically contains at least one (in some embodiments, at least 2, in some embodiments, in a range from 1 to 4) aromatic ring that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For epoxy resins containing two or more aromatic rings, the rings may be connected, for example, by a branched or straight-chain alkylene group having 1 to 4 carbon atoms that may optionally be substituted by halogen (e.g., fluoro, chloro, bromo, iodo).

Examples of aromatic epoxy resins useful for reaction with vinyl monocarboxylic acids include novolac epoxy resins (e.g., phenol novolacs, ortho-, meta-, or para-cresol novolacs or combinations thereof), bisphenol epoxy resins (e.g., bisphenol A, bisphenol F, halogenated bisphenol epoxies, and combinations thereof), resorcinol epoxy resins, and tetrakis phenylolethane epoxy resins. Examples of aromatic monomeric diepoxides useful for reaction with vinyl monocarboxylic acids include the diglycidyl ethers of bisphenol A and bisphenol F and mixtures thereof. In some embodiments, bisphenol epoxy resins, for example, may be chain extended to have any desirable epoxy equivalent weight. In some embodiments, the aromatic epoxy resin (e.g., either a bisphenol epoxy resin or a novolac epoxy resin) may have an epoxy equivalent weight of at least 140, 150, 200, 250, 300, 350, 400, 450, or 500 grams per mole. In some embodiments, the aromatic epoxy resin may have an epoxy equivalent weight of up to 2500, 3000, 3500, 4000, 4500, 5000, 5500, or 6000 grams per mole. In some embodiments, the aromatic epoxy resin may have an epoxy equivalent weight in a range from 150 to 6000, 200 to 6000, 200 to 5000, 200 to 4000, 250 to 5000, 250 to 4000, 300 to 6000, 300 to 5000, or 300 to 3000 grams per mole.

Several aromatic epoxy vinyl ester resins useful for the composition of the present disclosure are commercially available. For example, epoxy diacrylates such as bisphenol A epoxy diacrylates and epoxy diacrylates diluted with other acrylates are commercially available, for example, from Cytec Industries, Inc., Smyrna, Ga., under the trade designation “EBECRYL”. Aromatic epoxy vinyl ester resins such as novolac epoxy vinyl ester resins diluted with styrene are available, for example, from Ashland, Inc., Covington, Ky., under the trade designation “DERAKANE” (e.g., “DERAKANE 470-300”) and from Interplastic Corporation, St. Paul, Minn., under the trade designation “CoREZYN” (e.g., “CoREZYN 8730” and “CoREZYN 8770”).

A combination of unsaturated polyester resins and vinyl ester resins may be useful in the composition according to the present disclosure.

The composition of the present disclosure can have at least 10, 20, 25, 30, 40, or at least 50 percent by weight of any of the polymer resin comprising at least one α,β-unsaturated ester group described above or combination thereof. In some embodiments, the composition according to the present disclosure and/or useful for practicing the present disclosure can include up to 90, 80, 75, 70, 65, or 60 percent by weight of the polymer resin comprising at least one α,β-unsaturated ester group. These percentages are based on the total weight of the composition including the polymer resin comprising at least one α,β-unsaturated ester group, the acrylate or methacrylate, the vinyl ester, and the metal carboxylate.

The composition of the present disclosure and/or useful for practicing the present disclosure includes an acrylate or methacrylate. Examples of useful acrylates and methacrylates include methyl (meth)acrylate, ethyl (meth)acrylate, isopropyl (meth)acrylate, n-butyl (meth)acrylate, isobutyl (meth)acrylate, 2-ethylhexyl (meth)acrylate, lauryl (meth)acrylate, ethylene glycol dicyclopentenyl ether (meth)acrylate, and propanediol dicyclopentenyl ether (meth)acrylate. Hydroxy-functionalized (meth)acrylates that can be used in the composition of the present disclosure include hydroxyethyl methacrylate, hydroxypropyl methacrylate, hydroxyethyl acrylate, and hydroxypropyl acrylate. Multifunctional (meth)acrylate useful in the composition of the present disclosure include 1,4-butanediol diacrylate, 1,6-hexanediol diacrylate, diethylene glycol diacrylate, 1,3-butylene glycol diacrylate, neopentyl glycol diacrylate, cyclohexane dimethanol diacrylate, dipropylene glycoldiacrylate, ethoxylated bisphenol A diacrylate, trimethylolpropane triacrylate, pentaerythritol triacrylate, pentaerythritol tetraacrylate and their related (meth)acrylate derivatives. In some embodiments, the multi-functional acrylate or methacrylate comprises at least one of bis-acrylic acid or methacrylic acid esters of ethylene glycol, 1,4-butanediol and 1,6-hexanediol; tris-acrylic acid or methacrylic acid esters of glycerol, trimethylolpropane and pentaerythritol; tetrakis-acrylic acid or methacrylic acid esters of pentaerythritol; or alkoxylation of products of any of these and at least one of propylene oxide or ethylene oxide.

Urethane acrylates and methacrylates may also be useful for practicing the present disclosure. Urethane acrylates and methacrylates are typically products of difunctional or multifunctional isocyanate with a hydroxy-functionalized acrylate or methacrylate. The isocyanates may be isocyanate-terminal polyurethanes prepared from hydrocarbon, polyether, or polyester alcohols.

Some acrylates and methacrylates useful for practicing the present disclosure are commercially available including, for example, from Sartomer, Exton, Pa., a subsidiary of Arkema, under the trade designations “SR350”, “SR351H”, “SR205”, “SR206”, “SR248”, “CN991”, and “CN9006”.

The composition of the present disclosure and/or useful for practicing the present disclosure can have at least 1, 2.5, 5, or at least 10 percent by weight of any of the acrylates or methacrylates described above or combination thereof. In some embodiments, the composition according to the present disclosure and/or useful for practicing the present disclosure can include up to 50, 40, 35, 30, 25, or 20 percent by weight of any acrylate or methacrylate. These percentages are based on the total weight of the composition including the polymer resin comprising at least one α,β-unsaturated ester group, the acrylate or methacrylate, the vinyl ester, and the metal carboxylate.

The composition of the present disclosure and/or useful for practicing the present disclosure includes a vinyl ester represented by formula R—[C(O)—O—CH═CH₂]., wherein R is alkyl, aryl, or a combination thereof and n is 1 or 2. Examples of suitable R groups in the vinyl esters include alkyl having up to 10, 8, 6, or 4 carbon atoms, phenyl, and benzyl. In some embodiments, R is alkyl having up to 4 carbon atoms (e.g., methyl, ethyl, n-propyl, isopropyl, n-butyl, isobutyl, sec-butyl, or tert-butyl). In some embodiments, n is 1. Examples of suitable vinyl esters represented by formula R—C(O)—O—CH═CH₂ include vinyl acetate, vinyl propionate, vinyl pivalate, and vinyl benzoate. In some embodiments, the vinyl ester is vinyl acetate, vinyl propionate, or vinyl pivalate. In some embodiments, the vinyl ester is vinyl propionate or vinyl pivalate. The vinyl esters are commercially available from a number of chemical suppliers or can be prepared by known methods.

The composition of the present disclosure and/or useful for practicing the present disclosure can have at least 1, 2.5, 5, or at least 10 percent by weight of any of the vinyl esters represented by formula R—[C(O)—O—CH═CH₂]ₙ described above or combination thereof. In some embodiments, the composition according to the present disclosure and/or useful for practicing the present disclosure can include up to 50, 40, 35, 30, 25, or 20 percent by weight of any vinyl ester represented by formula R—[C(O)—O—CH═CH₂]ₙ. These percentages are based on the total weight of the composition including the polymer resin comprising at least one α,β-unsaturated ester group, the acrylate or methacrylate, the vinyl ester, and the metal carboxylate.

The composition of the present disclosure and/or useful for practicing the present disclosure includes a transition metal or post-transition metal salt of a carboxylic acid. The carboxylic acid can be saturated or unsaturated, can include from 2 to 30, 2 to 10, 3 to 10, or 8 to 22 carbon atoms, can be monofunctional or multifunctional, and can have one or more hydroxyl substituents. In some embodiments, the carboxylic acid useful for providing the metal salt is represented by formula R′COOH, wherein R′ is alkyl or alkenyl. In some embodiments, the carboxylic acid is acetic acid, propionate acid, or lactic acid. The common names of the fatty acids having from eight to twenty-six carbon atoms are caprylic acid (C₈), capric acid (C₁₀), lauric acid (C₁₂), myristic acid (C₁₄), palmitic acid (C₁₆), stearic acid (Cis), arachidic acid (C₂₀), behenic acid (C₂₂), lignoceric acid (C₂₄), and cerotic acid (C₂₆). Metal salts of these acids may be caprylate, caprate, laurate, myristate, palmitate, stearate, arachidate, behenate, lignocerate, and cerotate salts, in some embodiments. The salt can also be a naphthenate or a salt of linseed oil fatty acid. The transition metal is typically in the +2 oxidation state. Useful transition and post-transition metals for the metal salt include cobalt (II), copper (II), manganese (II), lead (II), tin (II), zinc (II), and iron (II). In some embodiments, the metal is a transition metal comprising at least one of copper, cobalt, or iron. In some embodiments, the metal salt of a carboxylic acid comprises at least one of iron (II) lactate hydrate, iron (II) naphthenate, or cobalt (II) naphthenate. In some embodiments, the metal salt of a carboxylic acid comprises at least one of iron (II) lactate hydrate or iron (II) naphthenate. The metal salts are commercially available from a variety of chemical suppliers or can be prepared by known methods.

The composition of the present disclosure and/or useful for practicing the present disclosure can have at least 0.1, 0.5, 1, 2, 3, 4, or at least 5 percent by weight of any of the metal salts of carboxylic acids described above or combination thereof. In some embodiments, the composition according to the present disclosure and/or useful for practicing the present disclosure can include up to 20, 15, or 10 percent by weight of any metal salt of a carboxylic acid. These percentages are based on the total weight of the composition including the polymer resin comprising at least one α,β-unsaturated ester group, the acrylate or methacrylate, the vinyl ester, and the metal salt of the carboxylic acid.

In some embodiments, the composition of the present disclosure and/or useful in the method of the present disclosure is substantially free of a vinyl aromatic compound having at least one vinyl substituent on an aromatic ring. In addition to the vinyl substituent, the vinyl aromatic compound may also include other substituents (e.g., alkyl, alkoxy, or halogen). Vinyl aromatic compounds having at least one vinyl substituent on an aromatic ring, typically a benzene ring or a naphthalene ring, can be useful diluents for polymer resins having at least one α,β-unsaturated ester group; however, they present some environmental health concerns as described above. Examples of such vinyl aromatic compounds include styrene, alpha-methyl styrene, p-methyl styrene, p-tert-butyl styrene, chlorostyrene, dichlorostyrene, p-ethoxystyrene, p-propoxystyrene, divinyl benzene, and vinyl naphthalene. “Substantially free” of vinyl aromatic compound having at least one vinyl substituent on an aromatic ring can mean that the composition according to the present disclosure and/or useful for practicing the present disclosure can include up to 2, 1, 0.5, 0.25, or 0.1 percent by weight of the vinyl aromatic compound. The composition according to the present disclosure and/or useful for practicing the present disclosure can be free of a vinyl aromatic compound having at least one vinyl substituent on an aromatic ring.

Reactive diluents useful in compositions containing a polyester resin comprising at least one α,β-unsaturated ester group also include vinyl ethers such as ethyl vinyl ether, n-propyl vinyl ether, iso-propyl vinyl ether, n-butyl vinyl ether, iso-butyl vinyl ether, cyclohexyl vinyl ether, hydroxybutyl vinyl ether, cyclohexanedimethanol divinyl ether, triethyleneglycol divinyl ether, butanediol divinyl ether, cyclohexanedimethanol monovinyl ether, diethyleneglycol divinyl ether, 2-ethylhexyl vinyl ether, dodecyl vinyl ether, octadecyl vinyl ether, hexanediol divinyl ether, dipropyleneglycol divinyl ether, and tripropyleneglycol divinyl ether. In some embodiments, the composition according to the present disclosure and/or useful for practicing the present disclosure can include up to 5, 4, 3, 2, 1, 0.5, 0.25, or 0.1 percent by weight of triethylene glycol divinyl ether or can be free of triethylene glycol divinyl ether. In some embodiments, the composition according to the present disclosure and/or useful for practicing the present disclosure can include up to 5, 4, 3, 2, 1, 0.5, 0.25, or 0.1 percent by weight of any vinyl ether or can be free of vinyl ethers. In some embodiments, the composition according to the present disclosure and/or useful for practicing the present disclosure can include up to 5, 4, 3, 2, 1, 0.5, 0.25, or 0.1 percent by weight of ethylene glycol dicyclopentenyl ether (meth)acrylate and propanediol dicyclopentenyl ether (meth)acrylate or can be free of ethylene glycol dicyclopentenyl ether (meth)acrylate and propanediol dicyclopentenyl ether (meth)acrylate. In some embodiments, the composition according to the present disclosure and/or useful for practicing the present disclosure can include up to 5, 4, 3, 2, 1, 0.5, 0.25, or 0.1 percent by weight lauryl (meth)acrylate or can be free of lauryl (meth)acrylate. These percentages are based on the total weight of polymeric resin, acrylate or methacrylate, and vinyl ester in the composition.

The composition according to the present disclosure and/or useful for practicing the present disclosure can include an adhesion promoter. In some embodiments, the adhesion promoter comprises at least one acid group and at least one carbon-carbon double bond or carbon-carbon triple bond. The adhesion promoter can be useful, for example, for improving adhesion to metal surfaces. The adhesion promoter can be an unsaturated carboxylic acid having at least six carbon atoms. The adhesion promoter can be an unsaturated fatty acid having up to 24 carbon atoms. The unsaturated carboxylic acid can have a range of 6 to 24, 8 to 22, or 8 to 20 carbon atoms and one, two, or three double bonds. In some embodiments, at least one of the carbon-carbon double bonds in the unsaturated carboxylic acid is a terminal double bond. In some embodiments, the adhesion promoter is 10-undecenoic acid. In some embodiments, the adhesion promoter is acrylic acid, maleic acid, methacrylic acid, monoalkyl esters of maleic acid, fumaric acid, monoalkyl esters of fumaric acid, itaconic acid, isocrotonic acid, crotonic acid, citraconic acid, and beta-carboxyethyl acrylate. In some embodiments, the adhesion promoter is acrylic acid, itaconic acid, or beta-carboxyethyl acrylate. In some embodiments, the adhesion promoter is 10-undecenoic acid, acrylic acid, itaconic acid, or beta-carboxyethyl acrylate. In some embodiments, the adhesion promoter is 10-undecenoic acid or acrylic acid. Other compounds that may be useful as adhesion promoters having at least one carbon-carbon double bond or carbon-carbon triple bond are those available, for example, from Sartomer USA under the trade designation “SR9050” and from Rhodia, Inc., La Défense, France, under the trade designation “SIPOMER PAM-200”. Other useful adhesion promoters include methacrylated fatty acids, such as those available, for example, from Croda Inc. Edison, N.J. or those available under the trade designation “MC818” from Dixie Chemical Company, Inc, Pasadena, Tex. Such compounds can also be prepared, for example, by the methods described in U.S. Pat. No. 8,372,926 (Palmese et al.).

The composition according to the present disclosure and/or useful for practicing the present disclosure can include an adhesion promoter comprising at least one mercaptan or amino group, which also may useful, for example, for improving adhesion to metal surfaces. Useful reactive compounds having one or more mercaptan groups include “POLYTHIOL QE-340M” curing agent from Toray Fine Chemicals, Co., Ltd., Tokyo, Japan, and a mercaptan terminated liquid resin, obtained under the trade designation “GABEPRO GPM-800” from Gabriel Performance Products, Akron, Ohio.

In some embodiments, the composition according to the present disclosure and/or useful for practicing the present disclosure includes an amino- or mercapto-substituted compound represented by formula (HD)₁₋₄-R. In this formula, each D is independently —S— or —N(H)—. In some embodiments, D is —N(H)—, and the compound represented by formula (HD)₁₋₄-R has at least one amino group. In some embodiments, when more than one DH group is present each one is either —S— or —N(H)—. In formula (HD)₁₋₄-R, R is a monovalent alkyl, alkenyl, or polyalkyleneoxy or a multivalent alkylene, alkenylene, or polyalkyleneoxy that is interrupted by at least two ether (i.e., —O—), amine (i.e., —N(H)—), amide (i.e., —N(H)—C(O)—), thioester (i.e., —S—C(O)—), or ester (i.e., —O—C(O)—) groups or a combination thereof. In some embodiments, R is alkenylene that is interrupted by at least one amine (i.e., —N(H)—) and at least one amide (i.e., —N(H)—C(O)—). In some embodiments, R is polyalkyleneoxy with a molecular weight up to 2500, 2000, 1500, 1000, or 500. In the polyalkyleneoxy, the alkylene groups comprise at least one of ethylene or propylene groups.

In some embodiments, the amino- or mercapto-substituted compound represented by formula (HD)₁₋₄-R is represented by formula HD-R¹-Q-R², wherein R¹ is alkylene that is interrupted by at least one —N(H)— or —O—; Q is —N(H)—C(O)—, —S—C(O)—, or —O—C(O)—; and R² is alkyl or alkenyl. In some of these embodiments, Q is —N(H)—C(O)— or —O—C(O)—. In some embodiments, Q is a —N(H)—C(O)—. In some embodiments, R² is alkyl or alkenyl having from 8 to 14, 8 to 13, or 8 to 12 carbon atoms. Compounds of formula HD-R¹-Q-R² can be made, for example, by reaction of a diamine or dithiol with a saturated or unsaturated fatty acid. Diamines and dithiols useful for making these compounds include polyethylenepolyamines (e.g., diethylenetriamine, triethylenetetramine, or tetraethylenepentamine) and polyether diamines with a molecular weight up to 2500, 2000, 1500, 1000, or 500, HSCH₂CH₂OCH₂CH₂OCH₂CH₂SH, pentaerythritol tetra(3-mercaptopropionate), trimethylolpropane tris(3-mercaptoproionate), and ethylene glycol bis (3-mercaptopropionate). Useful polyether amines are commercially available, for example, under the trade designation “JEFFAMINE” from Huntsman Chemical, The Woodlands, Tex., and from BASF, Florham Park, N.J. The molecular weights are typically provided by the manufacturer.

Useful compounds of formula HD-R¹-Q-R² include compounds in which D is —N(H)—, R¹ is alkylene that is interrupted by at least one —N(H)—, Q is —N(H)—C(O)—, and R² is alkenyl having 8 to 14 carbon atoms. In some embodiments, the compound represented by formula HD-R¹-Q-R² is H₂N(CH₂CH₂NH)₄C(O)(CH₂)₇C(H)═C(H)—(CH₂)₃CH₃.

In some embodiments, the adhesion promoter is present in an amount in a range from 0.05 weight percent to about 10 weight percent (in some embodiments, 0.1 weight percent to 5 weight percent, or 0.5 weight percent to 2 weight percent), based on the total weight of polymeric resin, acrylate or methacrylate, and vinyl ester in the composition.

In some embodiments, the composition according to and/or useful for practicing the present disclosure includes a surfactant, which may be useful, for example, for reducing the effect of oxygen on the polymerization at the surface. Useful surfactants include a wide variety of silicone-free defoamers. Examples of useful surfactants include those from BYK Additives & Instruments, Wesel, Germany, under the trade designations “BYK-1794”, “BYK-1790”, and “BYK-A 550”. In some embodiments, the surfactant is present in an amount in a range from 0.05 weight percent to about 5 weight percent (in some embodiments, 0.1 weight percent to 5 weight percent, or 0.5 weight percent to 2 weight percent), based on the total weight of polymeric resin, acrylate or methacrylate, and vinyl ester in the composition.

In some embodiments, the composition according to and/or useful for practicing the present disclosure includes a tertiary amine, which is useful for accelerating the free-radical curing of the composition at room temperature. Useful tertiary amines include N,N-dialkyl toluidines, where each alkyl group is optionally substituted by hydroxyl and independently selected from among methyl, ethyl, hydroxyethyl, hydroxylpropyl, isopropyl and mixtures thereof); trialkyl amines, where each alkyl is optionally substituted by hydroxyl and independently selected from among ethyl, propyl, and hydroxyethyl; N,N-dialkylanilines (e.g., N,N-dimethylaniline and N,N-diethylaniline); 4,4-bis(dimethylamino) diphenylmethane; and mixtures of any of these. In some embodiments, the accelerator is N,N-diisopropanol-p-toluidine, N,N-dihydroxyethyl-p-toluidine; N,N-methylhydroxyethyl-p-toluidine, or a mixture of these. The accelerator is generally present in a catalytic (that is, sub-stoichiometric) amount in the composition. Any useful amount of accelerator may be included in the composition. In some embodiments, an accelerator is included in the composition in an amount up to 2, 1, 0.75, or 0.5 percent by weight, based on the total weight of the composition.

The composition according to the present disclosure and/or useful for practicing the present disclosure can include one or more radical inhibitors. Examples of useful classes of radical inhibitors include phenolic compounds, stable radicals like galvinoxyl and N-oxyl based compounds, catechols, and phenothiazines. Examples of useful radical inhibitors that can be used in composition according to the present disclosure include 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, naphthoquinone, 1-oxyl-2,2,6,6-tetramethylpiperidine, 1-oxyl-2,2,6,6-tetramethylpiperidine-4-ol, 1-oxyl-2,2,6,6-tetramethylpiperidine-4-one, 1-oxyl-2,2,6,6-tetramethyl-4-carboxyl-piperidine, 1-oxyl-2,2,5,5-tetramethylpyrrolidine, 1-oxyl-2,2,5,5-tetramethyl-3-carboxylpyrrolidine, aluminium-N-nitrosophenyl hydroxylamine, diethylhydroxylamine, phenothiazine and/or derivatives or combinations of any of these compounds. Any useful amount of radical inhibitor may be included in the composition disclosed herein. In some embodiments, the amount of radical inhibitor in the composition according to the present disclosure is in the range of from 0.0001% to 10% (in some embodiments, 0.001% to 1%) by weight, based on the total weight of resin and other reactive components.

The composition according to the present disclosure may also include a filler. In some embodiments, the composition according to the present disclosure includes at least one of ceramic beads, polymer beads, silica, hollow ceramic elements, hollow polymeric elements, alumina, zirconia, mica, dolomite, wollastonite, fibers, talc, calcium carbonate, sodium metaborate, or clay. Such fillers, alone or in combination, can be present in the composition according to the present disclosure in a range from 10 percent by weight to 70 percent by weight, in some embodiments, 20 percent by weight to 60 percent by weight or 40 percent by weight to 60 percent by weight, based on the total weight of the composition including the polymer resin, acrylate or methacrylate, and vinyl ester. Silica, alumina, and zirconia, for example, can be of any desired size, including particles having an average size above 1 micrometer, between 100 nanometers and 1 micrometer, and below 100 nanometers. Silica can include nanosilica and amorphous fumed silica, for example. The term “ceramic” refers to glasses, crystalline ceramics, glass-ceramics, and combinations thereof. Hollow ceramic elements can include hollow spheres and spheroids. Examples of commercially available materials suitable for use as the hollow, ceramic elements include glass bubbles marketed by 3M Company, Saint Paul, Minn., as “3M GLASS BUBBLES” in grades K1, K15, K₂O, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”; glass bubbles marketed by Potters Industries, Carlstadt, N.J., under the trade designations “Q-CEL HOLLOW SPHERES” (e.g., grades 30, 6014, 6019, 6028, 6036, 6042, 6048, 5019, 5023, and 5028); and hollow glass particles marketed by Silbrico Corp., Hodgkins, Ill. under the trade designation “SIL-CELL” (e.g., grades SIL 35/34, SIL-32, SIL-42, and SIL-43). The hollow, ceramic elements may also be made from ceramics such as alpha-alumina, zirconia, and alumina silicates. In some embodiments, the hollow, ceramic elements are aluminosilicate microspheres extracted from pulverized fuel ash collected from coal-fired power stations (i.e., cenospheres). Useful cenospheres include those marketed by Sphere One, Inc., Chattanooga, Tenn., under the trade designation “EXTENDOSPHERES HOLLOW SPHERES” (e g., grades SG, MG, CG, TG, HA, SLG, SL-150, 300/600, 350 and FM-1). Other useful hollow, ceramic spheroids include silica-alumina ceramic hollow spheres with thick walls marketed by Valentine Chemicals of Lockport, La., as ZEEOSPHERES CERAMIC MICROSPHERES in grades N-200, N-200PC, N-400, N-600, N-800, N1000, and N1200. The hollow ceramic elements may have one of a variety of useful sizes but typically has a maximum dimension, or average diameter, of less than 10 millimeters (mm), more typically less than one mm. In some embodiments, the hollow ceramic elements have a maximum dimension in a range from 0.1 micrometer to one mm, from one micrometer to 500 micrometers, from one micrometer to 300 micrometers, or even from one micrometer to 100 micrometers. The mean particle size of the hollow, ceramic elements may be, for example, in a range from 5 to 250 micrometers (in some embodiments from 10 to 110 micrometers, from 10 to 70 micrometers, or even from 20 to 40 micrometers). As used herein, the term size is considered to be equivalent with the diameter and height, for example, of glass bubbles. In some embodiments, each of the fillers in the composition according to the present disclosure has a mean particle size up to 100 micrometers as described in U.S. Pat. No. 8,034,852 (Janssen et al.). Compositions according to the present disclosure can also include dyes, pigments, rheology modifiers (e.g., fumed silica or clay).

Compositions according to the present disclosure can be packaged, for example, as a two-part composition (e.g., body repair composition), wherein a first part comprises the composition including any of the components described above, and a second part comprises a free-radical initiator (e.g., organic peroxide or organic hydroperoxide). The volumetric ratio of the first to second part may be in the range of, e.g., 20:1 or higher, or 25:1 or higher, or 30:1 or higher for unsaturated polyester resins with a peroxide catalyst as an initiator.

Examples of useful organic peroxides and hydroperoxides include hydroperoxides (e.g., cumene, tert-butyl or tert-amyl hydroperoxide), dialkyl peroxides (e.g., di-tert-butylperoxide, dicumylperoxide, or cyclohexyl peroxide), peroxyesters (e.g., tert-butyl perbenzoate, tert-butyl peroxy-2-ethylhexanoate, tert-butyl peroxy-3,5,5-trimethylhexanoate, tert-butyl monoperoxymaleate, or di-tert-butyl peroxyphthalate), and diacylperoxides (e.g., benzoyl peroxide or lauryl peroxide). Other examples of useful organic peroxides include peroxycarbonates (e.g., tert-butylperoxy 2-ethylhexylcarbonate, tert-butylperoxy isopropyl carbonate, or di(4-tert-butylcyclohexyl) peroxydicarbonate) and ketone peroxides (e.g., methyl ethyl ketone peroxide, 1,1-di(tert-butylperoxy)cyclohexane, 1,1-di(tert-butylperoxy)-3,3,5-trimethylcyclohexane, and cyclohexanone peroxide). The organic peroxide may be selected, for example, based on the temperature desired for use of the organic peroxide and compatibility with the polymeric resin desired to be cured. For curing at room temperature, benzoyl peroxide, cumene hydroperoxide, cyclohexanone peroxide, diisopropylbenzene dihydroperoxide, t-butyl monoperoxymaleate, lauryl peroxide, methyl ethyl ketone peroxide, t-butyl hydroperoxide, or mixtures thereof may be useful. Any useful amount of organic peroxide and/or hydroperoxide may be combined with the composition. In some embodiments, at least one of a peroxide or hydroperoxide is combined with the composition in an amount up to 5, 3, 2.5, or 2 percent by weight, based on the total weight of the composition.

For convenience, when adding organic peroxides and hydroperoxides to a composition according to the present disclosure, the peroxide may be used in a formulation (e.g., paste) that also includes a diluent. The diluent can be a plasticizer, mineral spirits, water, or solvent (e.g., N-methyl-2-pyrrolidone, tetrahydrofuran, or ethyl acetate). For example, pastes made from benzoyl peroxide, ketone peroxides (e.g., methyl ethyl ketone peroxide), hydroperoxides (e.g., cumene hydroperoxide), peroxyesters (e.g., t-butyl peroxy-2-ethylhexanoate), and diperoxyketals are all sold commercially.

The free-radical initiator for curing the compositions according to the present disclosure may also be a photoinitiator. Examples of useful photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); 1-hydroxycyclohexyl phenyl ketone; and acylphosphine oxide derivatives and acylphosphonate derivatives (e.g., bis(2,4,6-trimethylbenzoyl)phenylphosphine oxide, diphenyl-2,4,6-trimethylbenzoylphosphine oxide, isopropoxyphenyl-2,4,6-trimethylbenzoylphosphine oxide, or dimethyl pivaloylphosphonate). Many photoinitiators are available, for example, from BASF under the trade designation “IRGACURE”. The photoinitiator may be selected, for example, based on the desired wavelength for curing and compatibility with the polymeric resin desired to be cured. When photochemical curing of the composition according to the present disclosure is desired, a photoinitiator can be included in the composition according to the present disclosure to make a one-part curable composition. Any useful amount of photoinitiator may be included the composition. In some embodiments, a photoinitiator is included the composition in an amount up to 3, 2.5, 2, or 1 percent by weight, based on the total weight of the composition.

The present disclosure provides a method of repairing a damaged surface. The method includes combining the composition described above in any of its embodiments with an organic peroxide or hydroperoxide, applying the composition comprising the organic peroxide or hydroperoxide to the damaged surface; and curing the composition on the damaged surface.

The present disclosure provides a cured composition made from the curable composition according to any of the above embodiments as well as an article comprising the cured composition on a surface.

One application of compositions according to the present disclosure are curable body repair materials useful in the repair of damaged vehicles and other equipment (e.g., cars, trucks, watercraft, windmill blades, aircraft, recreational vehicles, bathtubs, storage containers, and pipelines). Curable body repair materials can include two reactive components (e.g., a curable polymeric resin and catalyst or initiator) which are mixed together to form the curable body repair material.

In some embodiments of the method of the present disclosure, the damaged surface to be repaired is on at least a portion of a vehicle. Similarly, in some embodiments of the article of the present disclosure, the article is a portion of a vehicle.

The process of repairing dents and other damage using body repair materials can present challenges. For repairing an automobile, for example, a technician typically mixes the two reactive components and then uses a squeegee to spread the repair compound onto the surface of the vehicle to roughly match the contour of the surface. As the curable polymeric resin reacts with the curative or initiator, it hardens to a state where it can be shaped to match the contour of the vehicle before it was damaged. During this hardening process, the repair compound typically transitions from a state of soft, gelled material to a state of moderately hard material that is relatively easy to shape with an abrasive article (e.g., sandpaper) to a state of hard material. Body repair materials typically require handling in a relatively narrow time window. Premature sanding of body repair material before it has reached a critical amount of cure results in sandpaper becoming plugged reducing its effectiveness, the surface of the body repair material becoming rough, and sometimes the body repair material peeling away from the surface of the vehicle. If this situation occurs, then typically the body repair material has to be partially removed (usually by sanding) such that another layer of body repair material can be put on top and properly shaped. Furthermore, it is challenging for body repair materials to adhere well to a variety of common repair surfaces (e.g., aluminum, galvanized steel, E-coats, primers, and paints).

As shown in the Examples, below, the presence of the vinyl ester represented by formula R—C(O)—O—CH═CH₂ improves the surface polymerization of the unsaturated polyester and acrylate or methacrylate. Although we do not wish to be bound by any particular theory, we believe adding the metal salt of the carboxylic acid further promotes monomer consumption by converting the unreactive polymeric hydroperoxide (ROOH, from reaction of polymeric radical and oxygen) to reactive radical RO. and hydrogen oxide radical HO to further improve the polymerization and provide a non-tacky surface. When used as a body filler, the composition of the present disclosure can further provide a viscosity suitable for spreading, an onset of cure within about five minutes, a time for suitable sanding within ten minutes, and suitable adhesion to metal.

### Some Embodiments of the Disclosure

In a first embodiment, the present disclosure provides a composition comprising:

a polyester resin comprising at least one α,β-unsaturated ester group;

an acrylate or methacrylate;

a vinyl ester represented by formula R—[C(O)—O—CH═CH₂]ₙ, wherein R is alkyl, aryl, or a combination thereof, and n is 1 or 2; and

a metal salt of a carboxylic acid.

In a second embodiment, the present disclosure provides the composition of the first embodiment, wherein the composition is substantially free of a vinyl aromatic compound having at least one vinyl substituent on an aromatic ring.

In a third embodiment, the present disclosure provides the composition of the first or second embodiment, wherein the polyester resin comprises at least one of an unsaturated polyester resin having internal olefin groups, a dicyclopentadiene-modified unsaturated polyester resin, or an epoxy vinyl ester resin.

In a fourth embodiment, the present disclosure provides the composition of any one of the first to third embodiments, wherein the polyester resin comprises at least one of an unsaturated polyester resin, wherein the at least one α,β-unsaturated ester group comprises an internal olefin. (This unsaturated polyester resin need not be a dicyclopentadiene-modified unsaturated polyester resin).

In a fifth embodiment, the present disclosure provides the composition of any one of the first to fourth embodiments, wherein the polyester resin comprises a dicyclopentadiene-modified unsaturated polyester resin.

In a sixth embodiment, the present disclosure provides the composition of any one of the first to fifth embodiments, wherein the polyester resin comprises a dicyclopentenyl-end-capped unsaturated polyester resin.

In a seventh embodiment, the present disclosure provides the composition of any one of the first to sixth embodiments, wherein the polyester resin comprises an epoxy vinyl ester resin.

In an eighth embodiment, the present disclosure provides the composition of any one of the first to seventh embodiments, wherein the acrylate or methacrylate is multifunctional.

In a ninth embodiment, the present disclosure provides the composition of the eighth embodiment, wherein the multi-functional acrylate or methacrylate comprises at least one of bis-acrylic acid or methacrylic acid esters of ethylene glycol, 1,4-butanediol and 1,6-hexanediol; tris-acrylic acid or methacrylic acid esters of glycerol, trimethylolpropane and pentaerythritol; tetrakis-acrylic acid or methacrylic acid esters of pentaerythritol; or alkoxylation of products of any of these and at least one of propylene oxide or ethylene oxide.

In a tenth embodiment, the present disclosure provides the composition of any one of the first to ninth embodiments, wherein the metal salt of the carboxylic acid is a 2+ transition metal or post-transition metal salt.

In an eleventh embodiment, the present disclosure provides the composition of any one of the first to tenth embodiments, wherein the metal salt comprises at least one of an iron (II) carboxylate, a copper (II) carboxylate, or a cobalt (II) carboxylate.

In a twelfth embodiment, the present disclosure provides the composition of any one of the first to eleventh embodiments, wherein the metal salt of the carboxylic acid comprises at least one of iron (II) lactate hydrate, iron (II) naphthenate, or cobalt (II) naphthenate.

In a thirteenth embodiment, the present disclosure provides the composition of the twelfth embodiment, wherein the metal salt of the carboxylic acid comprises at least one of iron (II) lactate hydrate or iron (II) naphthenate.

In a fourteenth embodiment, the present disclosure provides the composition of any one of the first thirteenth embodiment, wherein R is alkyl having up to four carbon atoms.

In a fifteenth embodiment, the present disclosure provides the composition of any one of the first to fourteenth embodiments, wherein the vinyl ester comprises at least one of vinyl acetate, vinyl propionate, or vinyl pivalate or wherein the vinyl ester comprises at least one of vinyl propionate or vinyl pivalate.

In a sixteenth embodiment, the present disclosure provides the composition of any one of the twelfth to fifteenth embodiments, further comprising at least one of a surfactant, a free-radical inhibitor, or an adhesion promoter.

In a seventeenth embodiment, the present disclosure provides the composition of the sixteenth embodiment, wherein the composition comprises the adhesion promoter, and wherein the adhesion promoter comprises at least one acid group and at least one carbon-carbon double bond or carbon-carbon triple bond.

In an eighteenth embodiment, the present disclosure provides the composition of the sixteenth or seventeenth embodiment, further comprises inorganic filler.

In a nineteenth embodiment, the present disclosure provides the composition of the eighteenth embodiment, wherein the inorganic filler comprises at least one of ceramic beads, polymer beads, silica, hollow ceramic elements, hollow polymeric elements, alumina, zirconia, mica, dolomite, wollastonite, fibers, talc, calcium carbonate, or clay.

In a twentieth embodiment, the present disclosure provides the composition of any one of the first to fifteenth embodiments, further comprising a tertiary amine.

In a twenty-first embodiment, the present disclosure provides the composition of any one of the first to twentieth embodiments, wherein the tertiary amine comprises at least one N,N-dialkyl toluidine, where each alkyl group is independently methyl, ethyl, hydroxyethyl, hydroxylpropyl, or isopropyl.

In a twenty-second embodiment, the present disclosure provides the composition of any one of the first to twenty-first embodiments, wherein the composition is curable at room temperature.

In a twenty-third embodiment, the present disclosure provides the composition of any one of the first to twenty-second embodiments, wherein the composition is free of triethylene glycol divinyl ether.

In a twenty-fourth embodiment, the present disclosure provides the composition of any one of the first to twenty-third embodiments, wherein the composition is free of vinyl ethers.

In a twenty-fifth embodiment, the present disclosure provides the composition of any one of the first to twenty-fourth embodiments, wherein the composition is free of ethylene glycol dicyclopentenyl ether (meth)acrylate and propanediol dicyclopentenyl ether (meth)acrylate.

In a twenty-sixth embodiment, the present disclosure provides the composition of any one of the first to twenty-fifth embodiments, wherein the composition is free of lauryl (meth)acrylate.

In a twenty-seventh embodiment, the present disclosure provides the composition of any one of the first to twenty-sixth embodiments, wherein the polyester resin is not prepared from an alkoxylated 2-butene-1,4-diol.

In a twenty-eighth embodiment, the present disclosure provides the composition of any one of the first to twenty-seventh embodiments, packaged as a two-part body repair composition, wherein a first part comprises the composition and a second part comprises a free-radical initiator.

In a twenty-ninth embodiment, the present disclosure provides the composition of the twenty-eighth embodiment, wherein the free-radical initiator comprises at least one of an organic peroxide or organic hydroperoxide.

In a thirtieth embodiment, the present disclosure provides a method of repairing a damaged surface, the method comprising:

combining the composition of any one of the first to twenty-ninth embodiments with at least one of an organic peroxide or organic hydroperoxide;

applying the composition comprising the organic peroxide or organic hydroperoxide to the damaged surface; and

curing the composition on the damaged surface.

In a thirty-first embodiment, the present disclosure provides the method of the thirtieth embodiment, wherein the damaged surface is on at least a portion of a vehicle.

In a thirty-second embodiment, the present disclosure provides the method of the thirtieth or thirty-first embodiment, wherein curing is carried out at room temperature.

In a thirty-third embodiment, the present disclosure provides a cured composition prepared from the composition of any one of the first to twenty-ninth embodiments or prepared by the method of any one of the thirtieth to thirty-second embodiments.

In a thirty-fourth embodiment, the present disclosure provides an article prepared by curing the composition of any one of the first to twenty-ninth embodiments or prepared by the method of any one of the thirtieth to thirty-second embodiments.

In order that this disclosure can be more fully understood, the following examples are set forth. It should be understood that these examples are for illustrative purposes only and are not to be construed as limiting this disclosure in any manner.

### EXAMPLES

The following abbreviations are used to describe the examples:

° C.: degrees Centigrade

kPa: kilopascal

L: liter

mm: millimeter

pbw: parts by weight

wt. %: weight percent

Unless stated otherwise, all reagents were obtained or are available from chemical vendors such as Sigma-Aldrich Company, St. Louis, Mo., or may be synthesized by known methods. Unless otherwise reported, all ratios are by dry weight.

Abbreviations for materials and reagents used in the examples are as follows:
BHT: Butylated hydroxytoluene (also known as dibutylhydroxytoluene), obtained from Sigma Aldrich
BFP: A body filler powder composition, prepared as described below.
BPO: A blue dyed, 50 wt. % benzoyl peroxide paste, obtained from Raichem, s.r.l., Reggio Emilia, Italy.
BYK: An emission-free and silicone-free polymeric defoamer, obtained under the trade designation “BYK-1794” from Byk-Chemie, GmbH, Wesel, Germany.
DBQ: Glass hollow microspheres, obtained under the trade designation “Q-CEL 6717” from Potters Industries, Inc, Valley Forge, Pa.
HET: N,N-bis(2-hydroxyethyl-p-toluidine), obtained from Sigma-Aldrich Company.
ILH: Iron (II) lactate hydrate, obtained from Sigma-Aldrich Company.
MM: Talc, obtained under the trade designation “MISTRON MONOMIX” from Luzenac America, Centennial, ColoradoPIDE: 2,2′-(Phenyl-imino)diethanol
PR: Orthophthalic polyester resin having a weight average molecular weight from 2,500-3,000 g/mol, available from Polynt Composites U.S.A. Inc., North Kansas City, Mo.
SR-350: Trimethylol propane trimethacrylate, obtained under the trade designation “SR350” from Sartomer USA, LLC, Exton, Pa.
SR351H: Trimethylolpropane triacrylate, obtained under the trade designation “SR351H” from Sartomer USA, LLC.
SR-9050: Monofunctional methacrylate acid ester obtained under the trade designation “SR-9050” from Sartomer USA, LLC.
Talc: Talc, obtained under the trade designation “GRADE AB” from Luzenac America, Inc., Centennial, Colo.
TBP: tert butyl peroxy 3,5,5-trimethyl hexanoate.
TiO₂: Titanium dioxide, obtained under the trade designation “KRONOS 2310” from KronosWorldwide, Inc., Dallas, Tex.
TVP: Clay, obtained under the trade designation “TIXOGEL VP” from Southern Clay Products, Inc., Louisville, Ky.
VA: Vinyl acetate, obtained from Alfa-Aesar, Ward Hill, Mass.
VBC: Vinyl benzyl chloride, obtained from Dow Chemical Company, Midland, Mich.
VPI: Vinyl pivalate, obtained from Sigma-Aldrich Company.
VPR: Vinyl propionate, obtained from Sigma-Aldrich Company.
WM: Calcium carbonate, obtained under the trade designation “#10 White” from IMERYS, Roswell, Ga.
ZP: Zinc Phosphate, obtained under the trade designation “HALOX ZINC PHOSPHATE” from Halox, Hammond, Indian.

### Test Methods and Preparation Procedures

### Body Filler Powder (BFP) Preparation

338.64 parts by weight (pbw) Mistron Monomix, 98.94 pbw White Marble, 60.44 pbw zinc phosphate and 34.65 pbw Talc were manually blended into 38.20 pbw Tixogel VP in a 1 L plastic beaker, at 21° C., until homogeneous.

### Sanding Test Method

A 210 mm×100 mm steel panel was abraded with 80 grit sandpaper to roughen the surface. 100 g of a composition was mixed together, spreading on the panel and cured a composition, yielding a layer of the cured composition having a thickness of about 2 mm. After curing the composition, the composition was abraded with 80 grit sand paper and feathered along the edge of the layer in an attempt to get a fine feathered edge. A rating of 1 to 5 was given, 5 being the best and 1 being the worst. A rating of ‘5’ was given if the composition was easily ground into fine particles and produced a feathered edge. Poorer ratings were given if the sanding was not as easy, due to surface tack for example, and/or fine particles did not form upon sanding.

### Spreadability Test Method

Immediately after mixing a composition, the uncured composition was spread on paper for 45-60 seconds and the spreading behavior was qualitatively assessed. A rating of 1 to 5 was given, 5 being the best and 1 being the worst. A rating of ‘5’ was given if the mixture had very low viscosity and was smooth, very easy to mix, and did not stick to the spreader or paper in a fashion that hindered easy spreading. Lower ratings were given with increasing viscosity.

### Tack Test Method

A cured composition was touched with a gloved hand. A rating of 1 to 5 was given, 5 being the best and 1 being the worst. A rating of 5 was given if essentially no body filler was removed upon contact or rubbing, and no wetness remained upon the surface. A rating of 1 indicated significant surface tack or wetness.

### Cure Rate Test Method

The amount of time it took for the composition to cure was measured using a stop watch and by periodically checking the surface visually or by touching with a gloved hand. A rating of 1 to 5 was given, 5 being the best and 1 being the worst. A rating of 5 was given if the curing time for the surface fell between 4 and 20 minutes. Lower ratings were given, as the formulation fell further outside this range, either on the high end or low end. A composition was considered “cured” if upon applying pressure via touching, the composition did not flow or deform.

In all the above test methods, if a composition met or exceeded the minimum requirement, it was given a rating of ‘5’.

### Example 1

A composition was prepared as follows. To a small, approximately 0.5 inch (12.7 mm) diameter by 1.5 inch (38.1 mm) glass vial, was added, at 21° C., 1.00 grams PR, 0.05 grams SR9050, 0.04 grams BYK, 0.0075 grams BHT, 1.00 grams SR350, 0.75 grams VA and 0.06 grams HET. The vial was alternately mixed on a model Vortex-Genie Pulse Mixer, obtained from Scientific Industries, Inc., for several minutes, and gently warmed for several seconds by means of the heat gun, until the composition was homogeneous. 0.30 grams ILH was then added to the vial and mixing continued for approximately 30 seconds. 1.50 grams BFP was also added to the mixture and the vial returned to the mixer for another 2 minutes. Finally, 0.10 grams BPO was added and the composition mixed for approximately anther minute until homogeneous.

### Comparatives A-C and Examples 1-8

The procedure generally described for preparing Example 1 was repeated, wherein the composition was modified according to Table 1.

TABLE 1

| | Composition (grams) | | | | | | | | | | |
|---|---|---|---|---|---|---|---|---|---|---|---|
| | Example (Ex.)/Comparative Example (CE) | | | | | | | | | | |
| Component | Ex. 1 | CE-A | CE-B | Ex. 2 | Ex. 3 | Ex. 4 | Ex. 5 | Ex. 6 | Ex. 7 | CE-C | Ex. 8 |
| PR | 1.000 | 0 | 1.030 | 0.990 | 1.00 | 1.030 | 1.030 | 1.010 | 1.040 | 0.990 | 0.990 |
| SR9050 | 0.050 | 0 | 0.052 | 0.054 | 0.055 | 0.054 | 0.052 | 0.052 | 0.052 | 0.051 | 0.052 |
| BYK | 0.040 | 0 | 0 | 0.042 | 0 | 0.044 | 0.040 | 0.046 | 0 | 0.039 | 0.042 |
| BHT | 0.0075 | 0 | 0 | 0 | 0 | 0 | 0 | 0.008 | 0 | 0 | 0 |
| SR350 | 1.000 | 0 | 0 | 1.012 | 1.005 | 1.014 | 1.014 | 1.018 | 1.005 | 0.999 | 1.003 |
| VA | 0.750 | 1.00 | 1.758 | 0.786 | 0.763 | 0.772 | 0.748 | 0.749 | 0.753 | 0.778 | 0 |
| HET | 0.060 | 0.050 | 1.000 | 0.064 | 0.031 | 0.030 | 0.070 | 0.062 | 0.030 | 0.061 | 0 |
| ILH | 0.300 | 0 | 0 | 0.305 | 0 | 0.103 | 0.308 | 0.304 | 0.051 | 1.000 | 0.103 |
| BFP | 1.500 | 3.000 | 3.000 | 1.560 | 3.000 | 1.500 | 2.240 | 1.500 | 1.640 | 1.500 | 2.750 |
| BPO | 0.100 | 0.099 | 0.104 | 0.094 | 0.110 | 0.090 | 0.101 | 0.103 | 0.088 | 0.102 | 0.118 |
| SR351H | 0 | 1.758 | 0 | 0 | 0 | 0 | 0 | 0 | 0 | 0 | 0 |
| TBP | 0 | 0 | 0 | 0.002 | 0 | 0 | 0.001 | 0 | 0 | 0.002 | 0 |
| PIDE | 0 | 0 | 0 | 0 | 0 | 0 | 0 | 0 | 0 | 0 | 0.060 |

Results are listed in Table 2.

TABLE 2

| | Performance | | | | Total |
|---|---|---|---|---|---|
| Composition | Sanding | Spreadability | Tack | Cure Rate | Rating |
| Example 1 | 5 | 4 | 5 | 5 | 19 |
| CE-A | 2 | 4 | 2 | 3 | 11 |
| CE-B | 3 | 1 | 2 | 3 | 9 |
| Example 2 | 5 | 3 | 4 | 3 | 15 |
| Example 3 | 3 | 3 | 3 | 3 | 12 |
| Example 4 | 5 | 3 | 4 | 3 | 15 |
| Example 5 | 3 | 2 | 5 | 3 | 13 |
| Example 6 | 5 | 4 | 4 | 5 | 18 |
| Example 7 | 2 | 3 | 4 | 3 | 12 |
| CE-C | 1 | 3 | 2 | 3 | 9 |
| Example 8 | 4 | 3 | 5 | 4 | 16 |

### Examples 9-14

The procedure generally described for preparing Example 1 was repeated, wherein the vinyl acetate was substituted for a vinyl ester, according to the compositions listed in Table 3. Evaluations are listed in Table 4.

TABLE 3

| | Composition (grams) | | | | | |
|---|---|---|---|---|---|---|
| Component | Ex. 9 | Ex. 10 | Ex. 11 | Ex. 12 | Ex. 13 | Ex. 14 |
| PR | 1.900 | 1.010 | 1.010 | 1.010 | 1.025 | 0.999 |
| SR9050 | 0 | 0.050 | 0.055 | 0.053 | 0.050 | 0.050 |
| BYK | 0 | 0 | 0.0526 | 0.046 | 0.040 | 0.047 |
| BHT | 0 | 0 | 0.0074 | 0.0071 | 0.007 | 0.007 |
| SR350 | 0 | 0 | 1.015 | 1.035 | 0.063 | 0.992 |
| HET | 0 | 0.031 | 0.061 | 0.066 | 0 | 0.060 |
| ILH | 0 | 0 | 0.3360 | 0.318 | 0.300 | 0.297 |
| BFP | 4.700 | 3.000 | 1.500 | 1.500 | 1.500 | 1.500 |
| BPO | 0.200 | 0.1009 | 0.1012 | 0.102 | 0.100 | 0.1090 |
| SR351H | 1.994 | 0 | 0 | 0 | 0 | 0 |
| CN991 | 0.264 | 0 | 0 | 0 | 0 | 0 |
| VBC | 1.509 | 1.740 | 0 | 0 | 0 | 0 |
| VPI | 0 | 0 | 0.7552 | 0 | 0 | 0 |
| VPR | 0 | 0 | 0 | 0.754 | 0 | 0 |
| DVA | 0 | 0 | 0 | 0 | 1.750 | 0.768 |

Results are listed in Table 4.

TABLE 4

| | Performance | | | | |
|---|---|---|---|---|---|
| | | | | | Total |
| Composition | Sanding | Viscosity | Tack | Cure Rate | Rating |
| Example 9 | 3 | 5 | 4 | 1 | 13 |
| Example 10 | 2 | 2 | 2 | 3 | 9 |
| Example 11 | 4 | 4 | 5 | 5 | 18 |
| Example 12 | 4 | 4 | 4 | 5 | 17 |
| Example 13 | 1 | 5 | 1 | 1 | 8 |
| Example 14 | 3 | 4 | 4 | 2 | 13 |

Various modifications and alterations of this disclosure may be made by those skilled the art without departing from the scope and spirit of the disclosure, and it should be understood that this disclosure is not to be unduly limited to the illustrative embodiments set forth herein.

1. A composition comprising:
a polyester resin comprising at least one α,β-unsaturated ester group;
an acrylate or methacrylate;
a vinyl ester represented by formula R—[C(O)—O—CH═CH₂]ₙ wherein R is alkyl, aryl, or a combination thereof, and n is 1 or 2; and
a metal salt of a carboxylic acid.

2. The composition of claim 1, wherein the composition is substantially free of a vinyl aromatic compound having at least one vinyl substituent on an aromatic ring.

3. The composition of claim 1, wherein the polyester resin comprises at least one of an unsaturated polyester resin having internal olefin groups, a dicyclopentadiene-modified unsaturated polyester resin, or an epoxy vinyl ester resin.

4. The composition of claim 1, wherein the acrylate or methacrylate is a multi-functional acrylate or methacrylate comprising at least one of a bis-acrylic acid or methacrylic acid ester of ethylene glycol, 1,4-butanediol or 1,6-hexanediol; a tris-acrylic acid or methacrylic acid ester of glycerol, trimethylolpropane or pentaerythritol; a tetrakis-acrylic acid or methacrylic acid ester of pentaerythritol; or an acrylate or methacrylate ester of an alkoxylation product of any of ethylene glycol, 1,4-butanediol, 1,6-hexanediol, glycerol, trimethylolpropane, or pentaerythritol and at least one of propylene oxide or ethylene oxide.

5. The composition of claim 1, wherein the metal salt comprises at least one of an iron (II) carboxylate, copper (II) carboxylate, or cobalt (II) carboxylate.

6. The composition of claim 1, further comprising at least one of a surfactant, a free-radical inhibitor, or an adhesion promoter.

7. The composition of claim 1, further comprising inorganic filler.

8. The composition of claim 7, wherein the inorganic filler comprises at least one of ceramic beads, polymer beads, silica, hollow ceramic elements, hollow polymeric elements, alumina, zirconia, mica, dolomite, wollastonite, fibers, talc, calcium carbonate, or clay.

9. The composition of claim 1, further comprising a tertiary amine.

10. The composition of claim 9, wherein the tertiary amine comprises at least one N,N-dialkyl toluidine, where each alkyl group is independently methyl, ethyl, hydroxyethyl, hydroxylpropyl, or isopropyl.

11. The composition of claim 1, packaged as a two-part body repair composition, wherein a first part comprises the composition and a second part comprises at least one of an organic peroxide or organic hydroperoxide.

12. An article prepared from the composition of claim 11 by combining the first part and the second part and curing the composition.

13. A method of repairing a damaged surface, the method comprising:
combining the composition of claim 1 with at least one of an organic peroxide or an organic hydroperoxide;
applying the composition comprising at least one of the organic peroxide or the organic hydroperoxide to the damaged surface; and
curing the composition on the damaged surface to provide a cured composition.

14. The method of claim 13, wherein the damaged surface is on at least a portion of a vehicle.

15. The method of claim 13, wherein curing is carried out at room temperature.

16. The composition of claim 6, wherein the composition comprises the adhesion promoter, and wherein the adhesion promoter comprises at least one acid group and at least one carbon-carbon double bond or carbon-carbon triple bond.

17. The composition of claim 1, wherein the polyester resin comprises a dicyclopentadiene-modified unsaturated polyester resin.

18. The composition of claim 1, wherein the polyester resin comprises a dicyclopentenyl-end-capped unsaturated polyester resin.

19. The composition of claim 1, wherein the metal salt of the carboxylic acid is a 2+ transition metal or post-transition metal salt.

20. The composition of claim 1, wherein R is alkyl having up to four carbon atoms.
